(19) United States
(12) Patent Application Publication
(10) Pub. No.: US 2021/0004811 A1
(43) Pub. Date: Jan. 7, 2021

(54) FACIAL RECOGNITION PAYMENT

(71) Applicant: Advanced New Technologies Co., Ltd., George Town (KY)

(72) Inventors: Liang Zhou, Hangzhou (CN); Shumin Lin, Hangzhou (CN); Xuan Jiang, Hangzhou (CN); Hongmin Chen, Hangzhou (CN); Lei Guo, Hangzhou (CN); Jun Ma, Hangzhou (CN)

(73) Assignee: Advanced New Technologies Co., Ltd., George Town (KY)

(21) Appl. No.: 16/804,433

(22) Filed: Feb. 28, 2020

Related U.S. Application Data
(63) Continuation of application No. PCT/CN2020/071596, filed on Jan. 11, 2020.

(30) Foreign Application Priority Data
Jul. 1, 2019 (CN) 201910586693.X

(51) Int. Cl. G06Q 20/40; G06K 9/00

(52) U.S. Cl. CPC G06Q 20/40145; G06K 9/00288

(57) ABSTRACT

Implementations of the present specification provide facial recognition payment methods and apparatuses. The method includes the following: receiving as input a payment amount; collecting face image information of a payer when receiving a facial recognition payment request; and sending a payment request to a payment server, where the payment request includes the payment amount, a device identifier of a facial recognition payment device, and the face image information, so that the payment server determines an account bound to payee based on the device identifier, and transfers the payment amount to the payee account from a payer account corresponding to the face image information.

### CROSS-REFERENCE TO RELATED APPLICATIONS

This application is a continuation of PCT Application No. PCT/CN2020/071596, filed on Jan. 11, 2020, which claims priority to Chinese Patent Application No. 201910586693.X, filed on Jul. 1, 2019, and each application is hereby incorporated by reference in its entirety.

### TECHNICAL FIELD

The present disclosure relates to the field of payment technologies, and in particular to facial recognition payment methods and apparatuses.

### BACKGROUND

As network technologies develop, cashier register methods are more diversified. Conventional cash settlement at a cashier has been developed into mobile payment to improve payment convenience.

### SUMMARY

One or more implementations of the present specification provide facial recognition payment methods and apparatuses, to reduce costs for using facial recognition payment and improve convenience.

One or more implementations of the present specification are implemented by using the following technical solutions:

According to a first aspect, a facial recognition payment method is provided, where the method is performed by a facial recognition payment device, and the method includes the following: receiving as input a payment amount; collecting face image information of a payer when receiving a facial recognition payment request; and sending a payment request to a payment server, where the payment request includes the payment amount, a device identifier of the facial recognition payment device, and the face image information, so that the payment server determines an account bound to payee based on the device identifier, and transfers the payment amount to the payee account from a payer account corresponding to the face image information.

According to a second aspect, a facial recognition payment method is provided, where the method is performed by a payment server, and the method includes the following: receiving a payment request from a facial recognition payment device, where the payment request includes a payment amount, a device identifier of the facial recognition payment device, and face image information of a payer; and the payment amount is an amount received as input by the facial recognition payment device; determining an account bound to payee based on the device identifier, and determining an account bound to payer based on the face image information; and transferring the payment amount from the payer account to the payee account.

According to a third aspect, a facial recognition payment apparatus is provided, where the apparatus is applied to a facial recognition payment device, and the apparatus includes the following: a data receiving module, configured to receive as input a payment amount; an information collection module, configured to collect face image information of a payer when receiving a facial recognition payment request; and a request sending module, configured to send a payment request to a payment server, where the payment request includes the payment amount, a device identifier of the facial recognition payment device, and the face image information, so that the payment server determines an account bound to payee based on the device identifier, and transfers the payment amount to the payee account from a payer account corresponding to the face image information.

According to a fourth aspect, a facial recognition payment apparatus is provided, where the apparatus is applied to a payment server, and the apparatus includes the following: a request receiving module, configured to receive a payment request from a facial recognition payment device, where the payment request includes a payment amount, a device identifier of the facial recognition payment device, and face image information of a payer; and the payment amount is an amount received as input by the facial recognition payment device; an account determination module, configured to determine an account bound to payee based on the device identifier, and determine an account bound to payer based on the face image information; and a transfer processing module, configured to transfer the payment amount from the payer account to the payee account.

According to a fifth aspect, a facial recognition payment device is provided, where the device includes at least one memory, at least one processor, and at least one computer instruction that is stored in the memory and is executable on the processor, and the processor executes the instruction to implement any facial recognition payment method in the present specification.

According to the facial recognition payment method and apparatus in one or more implementations of the present specification, the binding relationship is established between the facial recognition payment device and the merchant's payee account, so that the facial recognition payment device can directly input the payment amount and process payment by using the facial recognition payment method without using a cashier register system. The solution reduces the costs for facial recognition payment, makes facial recognition payment more convenient, and greatly facilitates the use of facial recognition payment by small-sized merchants.

### BRIEF DESCRIPTION OF DRAWINGS

To describe technical solutions in one or more implementations of the present specification or in the existing technology more clearly, the following briefly describes the accompanying drawings needed for describing the implementations or the existing technology. Clearly, the accompanying drawings in the following descriptions merely show some implementations of the one or more implementations of the present specification, and a person of ordinary skill in the art can still derive other drawings from these accompanying drawings without creative efforts.

FIG. 1 is a schematic diagram illustrating a facial recognition payment device, according to one or more implementations of the present specification;

FIG. 2 is a schematic diagram illustrating an account binding operation, according to one or more implementations of the present specification;

FIG. 3 is a schematic diagram illustrating an account binding process, according to one or more implementations of the present specification;

FIG. 4 is a flowchart illustrating a facial recognition payment method, according to one or more implementations of the present specification;

FIG. 5 is a schematic diagram illustrating an amount input interface, according to one or more implementations of the present specification;

FIG. 6 is a schematic diagram illustrating a face collection operation, according to one or more implementations of the present specification;

FIG. 7 is a schematic diagram illustrating number input, according to one or more implementations of the present specification;

FIG. 8 is a schematic structural diagram illustrating a facial recognition payment apparatus, according to one or more implementations of the present specification;

FIG. 9 is a schematic structural diagram illustrating a facial recognition payment apparatus, according to one or more implementations of the present specification;

FIG. 10 is a schematic structural diagram illustrating a facial recognition payment apparatus, according to one or more implementations of the present specification.

### DESCRIPTION OF IMPLEMENTATIONS

The following describes the technical solutions in the one or more implementations of the present specification with reference to the accompanying drawings in the one or more implementations of the present specification. Clearly, the described implementations are merely some but not all of the implementations of the present specification. All other implementations obtained by a person of ordinary skill in the art based on the one or more implementations of the present specification without creative efforts shall fall within the protection scope of the present disclosure.

At least one implementation of the present specification provides a facial recognition payment device, and further provides a facial recognition payment method using the facial recognition payment device.

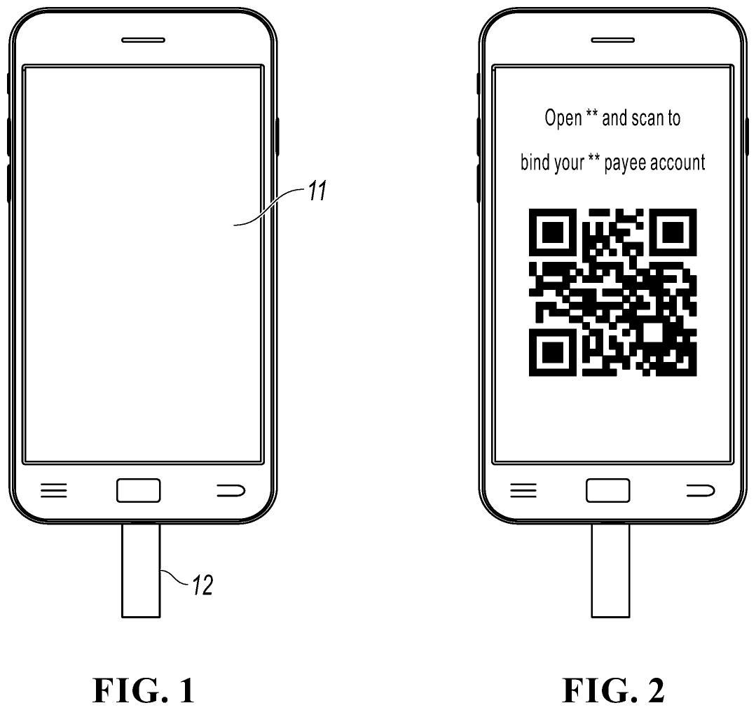

FIG. 1 illustrates a facial recognition payment device. The facial recognition payment device can include a screen 11. A user can perform an operation on the screen 11 to complete payment. The device can further include other components such as a support part 12. The user of the facial recognition payment device can place the device at an appropriate position by using the support part 12, for example, on a steady platform.

The facial recognition payment device in some implementations of the present specification can be applied to facial recognition payment in addition to or instead of installing a cashier register system, providing great convenience for small-sized merchants. The following describes in detail how to implement the device:

The device is bound to a payee account.

Before the device is used for facial recognition payment, the device can be bound to a merchant's payee account.

References can be made to an example in FIG. 2. The merchant can perform an operation on the screen of the facial recognition payment device, to trigger the device to display a graphic code. For example, the graphic code in FIG. 2 is a two-dimensional barcode.

For example, the screen of the facial recognition payment device can display a two-dimensional barcode:

The two-dimensional barcode can specify a device identifier of the facial recognition payment device.

The screen can also display the following prompt information: open ** and scan to bind your ** payee account, where “**” represents certain payment software such as ALIPAY. The payment software to be used is not limited in the present implementation.

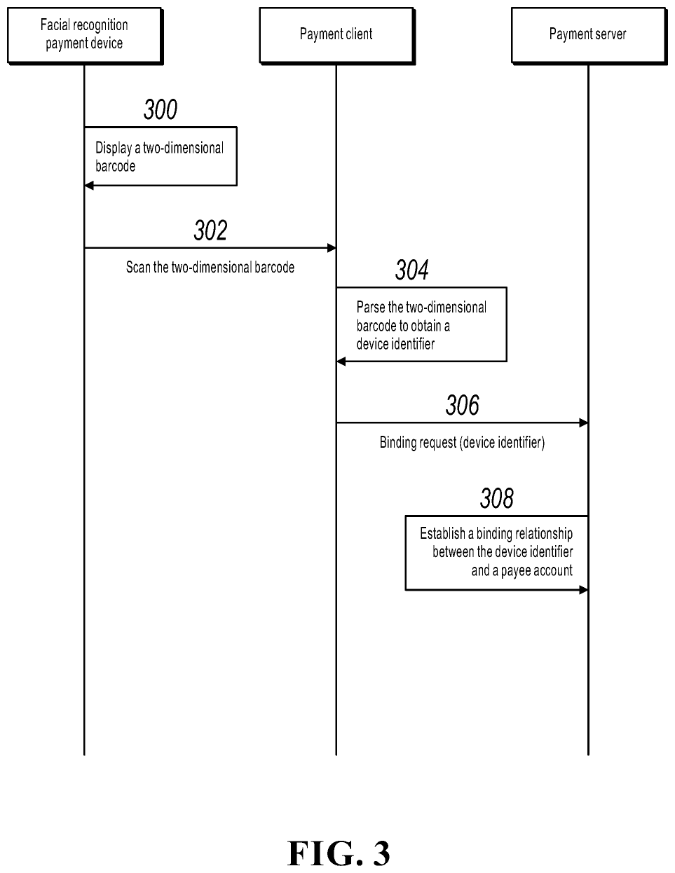

The merchant can open its own payment client (for example, a certain payment APP installed on a mobile phone) to scan the previous two-dimensional barcode. The payment client will obtain the device identifier included in the two-dimensional barcode. For the process of binding the device and the merchant's payee account by scanning the two-dimensional barcode, references can be made to FIG. 3.

In step 300, the facial recognition payment device displays a two-dimensional barcode.

In step 302, the merchant's payment client scans the two-dimensional barcode on the facial recognition payment device.

In step 304, the payment client obtains the device identifier of the facial recognition payment device included in the two-dimensional barcode through parsing.

In the present step, for example, the merchant (that is, the payee) scans a two-dimensional barcode by using a certain payment APP on the merchant's mobile phone, to obtain the device identifier included in the two-dimensional barcode.

In step 306, the payment client sends a binding request to a payment server, where the binding request includes the device identifier of the facial recognition payment device and a payee account identifier.

In the present step, the payment client can add the payee account identifier to the binding request. The payee account identifier enables the server to determine a unique corresponding payee account based on the payee account identifier. In addition, the binding request further includes the device identifier of the facial recognition payment device obtained by scanning the code.

In step 308, the payment server establishes a binding relationship between the payee account corresponding to the payee account identifier and the device identifier.

In the present step, the payment server can establish a mapping relationship between the payee account and the device identifier, so as to establish the binding between the facial recognition payment device and the merchant's payee account.

After the binding is complete, a prompt can be sent to prompt the merchant that the binding has been completed and facial recognition payment can be made. The prompt indicating that the binding is complete can be displayed on at least one of the facial recognition payment device or the merchant's payment client.

The device is applied to facial recognition payment.

After the binding relationship is established by scanning the code, the facial recognition payment device is already bound to the merchant's payee account and can be used for facial recognition payment.

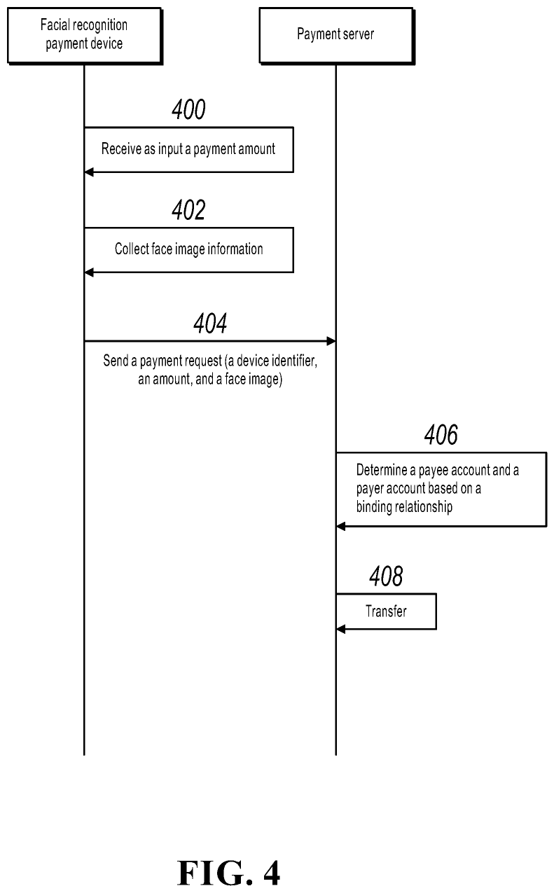

FIG. 4 describes the process of the facial recognition payment method, according to at least one implementation of the present specification, including the following:

In step 400, the facial recognition payment device receives as input a payment amount.

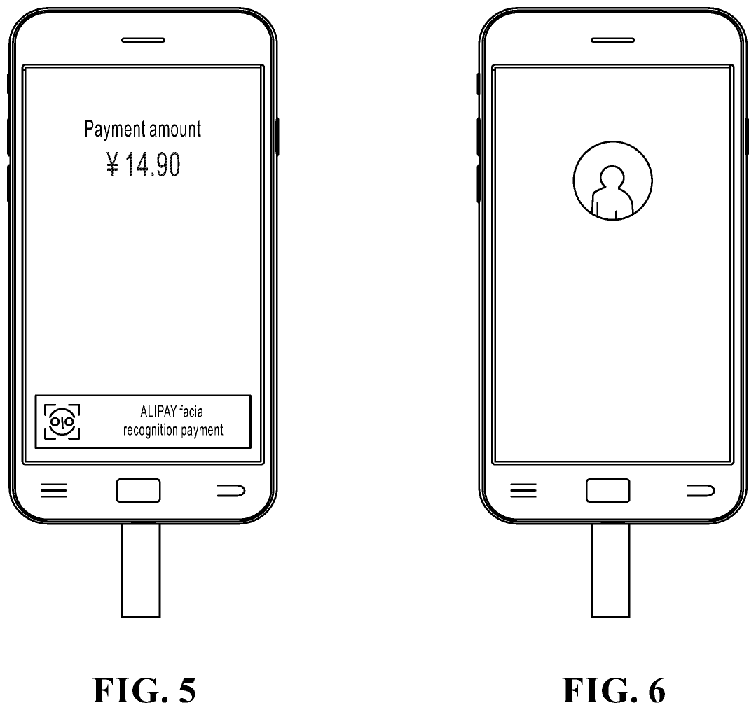

For example, the merchant can perform an operation on the facial recognition payment device to display a payment amount input interface, as shown in FIG. 5. Assume that the current payment is 14.90 yuan. Then, 14.90 can be entered.

It is worthwhile to note that, in the present example, the merchant can directly enter the payment amount, whereas in the conventional method, the merchant needs to scan a bar code of a product by using a cashier register system, and then the cashier register system determines a payment amount based on a detailed price of the product. The facial recognition payment device in the present implementation does not need to be equipped with a cashier register system, and the merchant can directly enter a payment amount. The payment amount can be manually calculated by the merchant, for example, can be calculated by an owner of a fruit shop based on some kinds of fruits purchased by a customer.

In step 402, the facial recognition payment device collects face image information of a payer when receiving a facial recognition payment request.

Referring back to FIG. 5, after the merchant enters the payment amount, the payer can select a payment method.

Assume that the payer selects the facial recognition payment method. A camera on the device is woken up to collect a face image, as shown in FIG. 6. The facial recognition payment method can be selected and triggered by the payer or the merchant on the facial recognition payment device.

In addition, face verification for facial recognition payment can be performed on the payment server. Then, the facial recognition payment device can send the collected face image information to the server in step 404. The face image information can be a face image, or can be a face feature extracted from the face image.

In step 404, the facial recognition payment device sends a payment request to the payment server, where the payment request includes the payment amount, the device identifier of the facial recognition payment device, and the face image information.

In the present step, the facial recognition payment device sends the payment request to the payment server, where the request includes the payment amount, the device identifier, and the face image information that are previously obtained . In addition, the payment request does not include account information of a payee account. The account information can be information that can uniquely identify the merchant's payee account, for example, the account information includes but is not limited to a system identifier of the merchant's cashier register system (the cashier register system is bound to the merchant's payee account), the payee account, an account identifier of the payee account (the identifier can be allocated by the payment system and the payee account can be determined based on the identifier), etc.

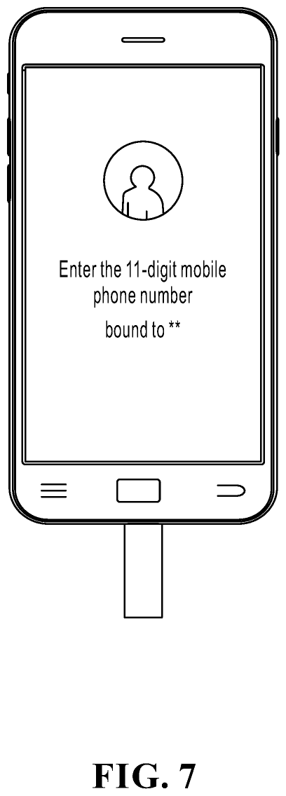

In addition, to improve security of facial recognition payment, the facial recognition payment device can further receive a payer account identifier of the payer, and the payer account identifier can be, for example, a mobile phone number of the payer. The payment request sent in the present step can further include the mobile phone number. As shown in FIG. 7, the facial recognition payment device can receive the mobile phone number entered by the payer. After entering the mobile phone number, the payer can tap the payment option on the screen of the facial recognition payment device, and the facial recognition payment device sends a payment request to the payment server.

In step 406, after receiving the payment request, the payment server determines an account bound to payee based on the device identifier, and determines an account bound to payer based on the face image information.

In the present step, the payment server can determine the payee account of the bound merchant based on the device identifier of the facial recognition payment device, and determine the account bound to payer based on the face image information. During payer account registration, the payer has established the binding relationship between the account and the face image information of the payer when registering a payment account in advance. Therefore, the payer account corresponding to the face image information can be determined based on the binding relationship.

In addition, if the payment request also includes the mobile phone number entered by the payer, to increase security of facial recognition payment, the payment server can determine the corresponding payer account based on the mobile phone number, and check whether the payer account determined based on the mobile phone number is consistent with the payer account determined based on the face image information. If no, the payment server can determine that the verification for facial recognition payment fails. If yes, the payment server can proceed to step 408.

In step 408, the payment server transfers the payment amount from the payer account to the payee account.

After the transfer is complete, the payment server can separately send a payment completion prompt to the APP corresponding to the merchant's payee account and the APP corresponding to the payer's payer account.

According to the facial recognition payment method in the present implementation, the binding relationship is established between the facial recognition payment device and the merchant's payee account, so that the facial recognition payment device can directly input the payment amount and process payment by using the facial recognition payment method without using a cashier register system. The solution reduces the costs for facial recognition payment, makes facial recognition payment more convenient, and greatly facilitates the use of facial recognition payment by small-sized merchants.

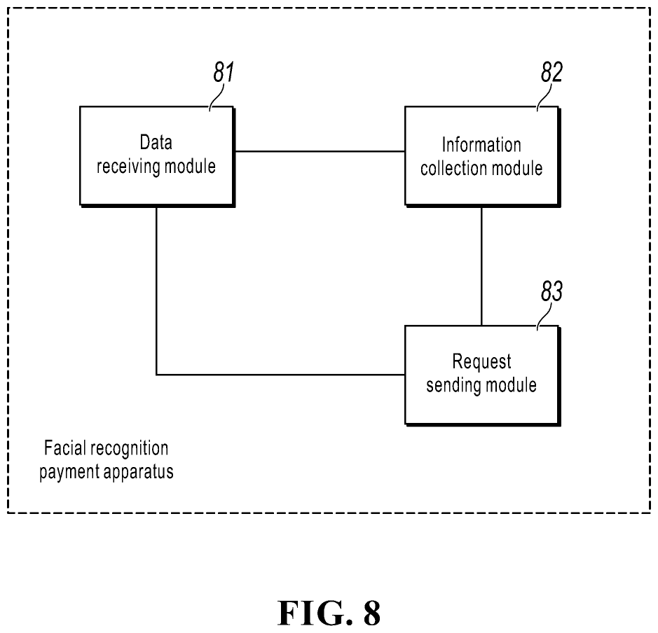

FIG. 8 provides a facial recognition payment apparatus. The apparatus can be applied to a facial recognition payment device, so that the facial recognition payment device can perform the facial recognition payment method according to any implementation of the present specification. As shown in FIG. 8, the apparatus can include a data receiving module 81, an information collection module 82, and a request sending module 83.

The data receiving module 81 is configured to receive as input a payment amount.

The information collection module 82 is configured to collect face image information of a payer when receiving a facial recognition payment request.

The request sending module 83 is configured to send a payment request to a payment server, where the payment request includes the payment amount, a device identifier of the facial recognition payment device, and the face image information, so that the payment server determines an account bound to payee based on the device identifier, and transfers the payment amount to the payee account from a payer account corresponding to the face image information.

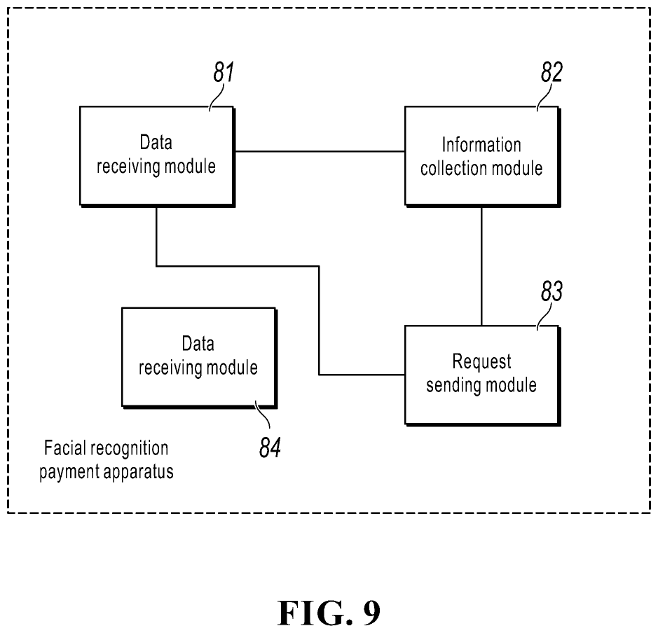

As shown in FIG. 9, based on the structure shown in FIG. 8, the facial recognition payment apparatus can further include a graphic display module 84, configured to display a graphic code, where the graphic code includes the device identifier, so that a payment client of a payee scans the graphic code and then requests the payment server to establish a binding relationship between the device identifier and the payee account.

In an example, the payment request sent by the request sending module 83 does not include account information of the payee account.

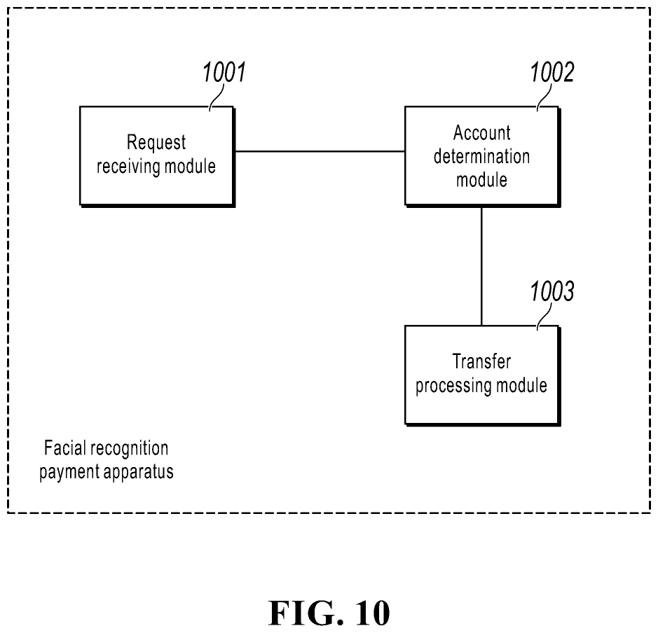

FIG. 10 provides a facial recognition payment apparatus. The apparatus can be applied to a payment server, so that the payment server can perform the facial recognition payment method according to any implementation of the present specification. As shown in FIG. 10, the apparatus can include a request receiving module 1001, an account determination module 1002, and a transfer processing module 1003.

The request receiving module 1001 is configured to receive a payment request from a facial recognition payment device, where the payment request includes a payment amount, a device identifier of the facial recognition payment device, and face image information of a payer; and the payment amount is an amount received as input by the facial recognition payment device.

The account determination module 1002 is configured to determine an account bound to payee based on the device identifier, and determine an account bound to payer based on the face image information.

The transfer processing module 1003 is configured to transfer the payment amount from the payer account to the payee account.

The apparatus or module illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

For ease of description, the previous apparatus is described by dividing functions into various modules. Certainly, when one or more implementations of the present specification are implemented, a function of each module can be implemented in one or more pieces of software and/or hardware.

The sequence of performing the steps in the process shown in the previous figure is not limited to the sequence in the flowchart. In addition, the description of each step can be implemented in the form of software, hardware, or a combination of software and hardware. For example, a person skilled in the art can implement each step in the form of software code, and can be a computer executable instruction capable of implementing a logical function corresponding to the step. When the step is implemented in the form of software, the executable instruction can be stored in a memory and be executed by a processor in the device.

For example, corresponding to the previous method, one or more implementations of the present specification all provide a facial recognition payment device. The device can include at least one processor, at least one memory, and at least one computer instruction that is stored in the memory and is executable on the processor. The processor executes the instruction to implement the facial recognition payment method according to any implementation of the present specification.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

A person skilled in the art should understand that one or more implementations of the present specification can be provided as a method, a system, or a computer program product. Therefore, one or more implementations of the present specification can use a form of hardware only implementations, software only implementations, or implementations with a combination of software and hardware. Moreover, one or more implementations of the present specification can use a form of a computer program product that is implemented on one or more computer-usable storage media (including but not limited to a disk memory, a CD-ROM, an optical memory, etc.) that include computer-usable program code.

One or more implementations of the present specification can be described in the general context of computer-executable instructions, for example, a program module. Generally, the program module includes a routine, a program, an object, a component, a data structure, etc. executing a specific task or implementing a specific abstract data type. One or more implementations of the present specification can alternatively be practiced in distributed computing environments in which tasks are performed by remote processing devices that are connected through a communications network. In a distributed computing environment, the program module can be located in both local and remote computer storage media including storage devices.

The implementations in the present specification are described in a progressive way. For same or similar parts of the implementations, references can be made to the implementations mutually. Each implementation focuses on a difference from other implementations. Particularly, a data processing device implementation is similar to a method implementation, and therefore is described briefly. For related parts, references can be made to related descriptions in the method implementation.

Specific implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or can be advantageous.

The previous descriptions are only example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

1. A computer-implemented method comprising:
generating, by a payment server, a prompt responsive to establishing a binding relationship between an account bound to a payee and a device identifier of a facial recognition payment device;
transmitting, by the payment server, the prompt to at least one of the facial recognition payment device or a payment client of the payee, wherein the prompt is transmitted over a communications network connecting the payment server to at least one of the facial recognition payment device or the payment client of the payee;
receiving, by the payment server, a payment request from the facial recognition payment device, wherein the payment request comprises a payment amount, the device identifier of the facial recognition payment device, and face image information of a payer; and the payment amount is an amount received as input by the facial recognition payment device;
determining the account bound to the payee based on the device identifier and the binding relationship, and determining an account bound to the payer based on the face image information; and
transferring the payment amount from the account bound to the payer to the account bound to the payee.

2. The computer-implemented method of claim 1, wherein after determining the account bound to the payer based on the face image information, the method further comprises:
determining a payer account identifier of the account bound to the payer and adding the payer account identifier to the payment request.

3. The computer-implemented method of claim 1, wherein the payment request further comprises a mobile phone number of the payer; and before transferring the payment amount from the account bound to the payer to the account bound to the payee, the method further comprises:
determining a corresponding payer account based on the mobile phone number; and
determining the corresponding payer account matches the account bound to the payer determined based on the face image information.

4. The computer-implemented method of claim 1, wherein before receiving the payment request from the facial recognition payment device, the method further comprises:
receiving a binding request from the payment client of the payee, wherein the binding request comprises the device identifier of the facial recognition payment device and a payee account identifier of the payee; and
establishing the binding relationship between a payee account corresponding to the payee account identifier and the device identifier.

5. The computer-implemented method of claim 4 wherein the binding request comprises the device identifier of the facial recognition payment device and the payee account identifier of the payee, and wherein the binding request is initiated, in part, by displaying a graphic code configured to allow the payment client of the payee to scan the graphic code and request the payment server to establish the binding relationship between the device identifier and the payee account.

6. The method according to claim 1, wherein the payment request does not comprise account information of the account bound to the payee.

7. A non-transitory, computer-readable medium storing one or more instructions executable by a computer system to perform operations comprising:
generating, by a payment server, a prompt responsive to establishing a binding relationship between an account bound to a payee and a device identifier of a facial recognition payment device:
transmitting, by the payment server, the prompt to at least one of the facial recognition payment device or a payment client of the payee, wherein the prompt is transmitted over a communications network connecting the payment server to at least one of the facial recognition payment device or the payment client of the payee;
receiving, by the payment server, a payment request from the facial recognition payment device, wherein the payment request comprises a payment amount, the device identifier of the facial recognition payment device, and face image information of a payer; and the payment amount is an amount received as input by the facial recognition payment device;
determining the account bound to the payee based on the device identifier and the binding relationship, and determining an account bound to the payer based on the face image information; and
transferring the payment amount from the account bound to the payer to the account bound to the payee.

8. The non-transitory, computer-readable medium of claim 7, wherein after determining the account bound to the payer based on the face image information, the operations further comprise:
determining a payer account identifier of the account bound to the payer and adding the payer account identifier to the payment request.

9. The non-transitory, computer-readable medium of claim 7, wherein the payment request further comprises a mobile phone number of the payer; and before transferring the payment amount from the account bound to the payer to the account bound to the payee, the operations further comprise:
determining a corresponding payer account based on the mobile phone number; and
determining the corresponding payer account matches the account bound to the payer determined based on the face image information.

10. The non-transitory, computer-readable medium of claim 7, wherein before receiving the payment request from the facial recognition payment device, the operations further comprise:
receiving a binding request from the payment client of the payee, wherein the binding request comprises the device identifier of the facial recognition payment device and a payee account identifier of the payee; and
establishing the binding relationship between a payee account corresponding to the payee account identifier and the device identifier.

11. The non-transitory, computer-readable medium of claim 10 wherein the binding request comprises the device identifier of the facial recognition payment device and the payee account identifier of the payee, and wherein the binding request is initiated, in part, by displaying a graphic code configured to allow the payment client of the payee to scan the graphic code and request the payment server to establish the binding relationship between the device identifier and the payee account.

12. The non-transitory, computer-readable medium of claim 7, wherein the payment request does not comprise account information of the account bound to the payee.

13. A system, comprising:
one or more computers; and
one or more computer memory devices interoperably coupled with the one or more computers and having tangible, non-transitory, machine-readable media storing one or more instructions that, when executed by the one or more computers, perform one or more operations comprising:
generating, by a payment server, a prompt responsive to establishing a binding relationship between an account bound to a payee and a device identifier of a facial recognition payment device;
transmitting, by the payment server, the prompt to at least one of the facial recognition payment device or a payment client of the payee, wherein the prompt is transmitted over a communications network connecting the payment server to at least one of the facial recognition payment device or the payment client of the payee;
receiving, by the payment server, a payment request from the facial recognition payment device, wherein the payment request comprises a payment amount, the device identifier of the facial recognition payment device, and face image information of a payer; and the payment amount is an amount received as input by the facial recognition payment device;
determining the account bound to the payee based on the device identifier and the binding relationship, and determining an account bound to the payer based on the face image information; and
transferring the payment amount from the account bound to the payer to the account bound to the payee.

14. The system of claim 13, wherein after determining the account bound to the payer based on the face image information, the operations further comprise:
determining a payer account identifier of the account bound to the payer and adding the payer account identifier to the payment request.

15. The system of claim 13, wherein the payment request further comprises a mobile phone number of the payer; and before transferring the payment amount from the account bound to the payer to the account bound to the payee, the operations further comprise:
determining a corresponding payer account based on the mobile phone number; and
determining the corresponding payer account matches the account bound to the payer determined based on the face image information.

16. The system of claim 13, wherein before receiving the payment request from the facial recognition payment device, the operations further comprise:
receiving a binding request from the payment client of the payee, wherein the binding request comprises the device identifier of the facial recognition payment device and a payee account identifier of the payee; and
establishing the binding relationship between a payee account corresponding to the payee account identifier and the device identifier.

17. The system of claim 16, wherein the binding request comprises the device identifier of the facial recognition payment device and the payee account identifier of the payee, and wherein the binding request is initiated, in part, by displaying a graphic code configured to allow the payment client of the payee to scan the graphic code and request the payment server to establish the binding relationship between the device identifier and the payee account.

18. The system of claim 13, wherein the payment request does not comprise account information of the account bound to the payee.
